(19) United States
(12) Patent Application Publication
(10) Pub. No.: US 2016/0148530 A1
(43) Pub. Date: May 26, 2016

(54) METHOD AND SYSTEM FOR FACILITATING OVERCOMING OF ADDICTIVE BEHAVIOR

(71) Applicant: Health Seal Ltd., Petach-Tikva (IL)

(72) Inventor: Erez DAYAN, Petach Tikva (IL)

(21) Appl. No.: 14/551,133

(22) Filed: Nov. 24, 2014

(51) Int. Cl. G09B 19/00; G09B 7/00

(52) U.S. Cl. CPC G09B 19/00; G09B 7/00

(57) ABSTRACT

A method generating a questionnaire to facilitate overcoming addictive behavior by a client includes generating a series of questionnaires to be presented to the client. The questionnaires are designed to facilitate self-modification of a client behavior. Generating each questionnaire includes obtaining a response by the client to a previously presented questionnaire of the series of questionnaires. The client is automatically evaluated with respect to a change component in accordance with the obtained response and in accordance with responses of other clients to questionnaires that were previously presented to those other clients. The questionnaire is automatically generated in accordance with the evaluation with respect to the change component and in accordance with a self-modification of the client's behavior that is facilitative of overcoming the addictive behavior, the generated questionnaire being designed to facilitate the self-modification. The generated questionnaire is presented to the client.

### FIELD OF THE INVENTION

The present invention relates to a method and system for facilitating overcoming of addictive behavior.

### BACKGROUND OF THE INVENTION

Addictive behaviors of various types have been identified as a source of a wide range of health problems. Addictions have been linked to various chronic disorders. For example, obesity that results from addiction to overeating has been identified as a major cause or contributing factor to such disorders as heart and circulatory system diseases, stroke, hypertension, diabetes, high fat levels in blood, various malignancies, arthritis, liver and gallbladder disorders, sleep apnea, and a wide range of psychological disorders. Addiction to smoking has been identified as a cause of such disorders as heart and circulatory system diseases, stroke, respiratory disease, cancer, and diabetes. Other addictions, such as addiction to alcohol, drugs, gambling, sex, television, internet, exercise, work, or shopping, may have profound adverse social, economic, or psychological consequences, in addition to their effect on physical health.

In many cases, some or all of the adverse effects of the addiction may be partially or completely reversed by overcoming the addiction.

### SUMMARY OF THE INVENTION

There is thus provided, in accordance with some embodiments of the present invention, a method to facilitate overcoming addictive behavior by a client, the method including generating a series of questionnaires to be presented to the client, the questionnaires designed to facilitate self-modification of a client behavior, wherein the generating of each questionnaire of the series of questionnaires includes: obtaining a response by the client to a previously presented questionnaire of the series of questionnaires; automatically evaluating the client with respect to a change component in accordance with the obtained response and in accordance with responses of other clients to questionnaires that were previously presented to those other clients; automatically generating that questionnaire in accordance with the evaluation with respect to the change component and in accordance with a self-modification of the client's behavior that is facilitative for overcoming the addictive behavior, the generated questionnaire being designed to facilitate the self-modification; and presenting the generated questionnaire to the client.

Furthermore, in accordance with some embodiments of the present invention, the previously presented questionnaire includes a first questionnaire that is common to a group of clients to which the client belongs.

Furthermore, in accordance with some embodiments of the present invention, the other clients comprise clients who have been evaluated as having successfully performed a self-modification that is facilitative of overcoming their addictive behavior.

Furthermore, in accordance with some embodiments of the present invention, generating the questionnaire includes selecting a question from a database of questions.

Furthermore, in accordance with some embodiments of the present invention, selecting the question from the database of questions includes applying a rule.

Furthermore, in accordance with some embodiments of the present invention, generating the questionnaire includes selecting visible, audible or game content for presentation to the client.

Furthermore, in accordance with some embodiments of the present invention, generating the questionnaire includes instruction to the client to perform an activity.

Furthermore, in accordance with some embodiments of the present invention, generating the questionnaire includes selecting a questionnaire from a database of questionnaires.

Furthermore, in accordance with some embodiments of the present invention, generating the questionnaire further includes substituting a question in the selected questionnaire with a question that is selected from a database of questions.

Furthermore, in accordance with some embodiments of the present invention, generating the questionnaire includes selecting a font, text color, or background color.

Furthermore, in accordance with some embodiments of the present invention, the method further includes reporting a result of analysis of the client's response to one or more of the questionnaires.

Furthermore, in accordance with some embodiments of the present invention, questionnaires are presented to the client at predetermined time intervals.

Furthermore, in accordance with some embodiments of the present invention, the time intervals are variable.

There is further provided, in accordance with some embodiments of the present invention, a system for generating a questionnaire to facilitate overcoming addictive behavior by a client, the system including a processor that is in communication with an input device and an output device that are accessible by the client, and with a data storage device for storing programmed instructions, the processor configured to: obtain a response by the client to a previously presented questionnaire of a series of generated and presented questionnaires, each questionnaire of the series being designed to facilitate self-modification of a behavior of the client; automatically evaluate the client with respect to a change component in accordance with the obtained response and in accordance with responses of other clients to questionnaires that were previously presented to those other clients; automatically generate a questionnaire of the series in accordance with the evaluation with respect to the change component and in accordance with a self-modification of the client's behavior that is facilitative of overcoming the addictive behavior, the generated questionnaire designed to facilitate the self-modification; and present the generated questionnaire on the output device so as to enable the client to operate the input device to respond to the presented questionnaire.

Furthermore, in accordance with some embodiments of the present invention, the processor is configured to generate a first questionnaire that is common to a group of clients to which the client belongs.

Furthermore, in accordance with some embodiments of the present invention, the data storage device is configured to store a database and the processor is configured to generate the questionnaire by selecting a question or a questionnaire from the database.

Furthermore, in accordance with some embodiments of the present invention, the processor is configured to present each generated questionnaire of the series after a predetermined interval from the time that the response to the previous questionnaire was obtained.

Furthermore, in accordance with some embodiments of the present invention, the generated questionnaire includes visible, audible or game content.

Furthermore, in accordance with some embodiments of the present invention, the generated questionnaire includes an instruction to perform an activity.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1 is a schematic drawing of a system for questionnaire generation for overcoming of addictive behavior, in accordance with an embodiment of the present invention.

FIG. 2 is a flowchart depicting a method for questionnaire generation for overcoming of addictive behavior, in accordance with an embodiment of the present invention.

FIG. 3 is a flowchart depicting a method for facilitating overcoming of addictive behavior, in accordance with an embodiment of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

In accordance with some embodiments of the present invention, a person (referred to herein as a client) with an addiction or a tendency to an addiction is presented with a series of questionnaires. The client is requested to respond to questions in the questionnaire. As used herein, a questionnaire refers to a set of one or more questions.

As used herein, the terms “addictive behavior” and “addiction” are to be understood as interchangeable. It may be noted that there is a continuum from light addictive behavior that does not interfere with a persons quality of life, up to full-blown addiction that potentially threatens a person's physical, emotional, mental, or social wellbeing.

In accordance with an embodiment of the present invention, overcoming of addictive behavior by a client may be facilitated by parallel processes that help in developing self-modification of behavior. For example, facilitating the self-modification may include facilitating one or more change components in the client. Such change components may include development of self-love, modifying limiting beliefs, increasing balance between emotional, physical, and mental levels, facilitating development of self control and commitment to the process, and creating significant triggers for developing the motivation for self modification of behavior.

A series of questions or questionnaires is generated to be presented to the client. The questionnaires are designed to develop self-awareness on the physical, emotional and mental levels as well as motivation, and self-efficacy for self-modifying behavior and for maintaining the modification in the long term.

The system may adapt the questions to the basic beliefs of the customer, to right brain activation, to encourage taking responsibility, to developing creativity and self-leadership, to developing the client's intuition and self-expression, to acquiring attitudes such as gratitude, to developing motivation to continue the process, and to deal with difficulties. The system may build an action plan for the client (e.g., involving activities outside of the system).

A questionnaire may include vocal or audio reminders (e.g., to perform an action), graphic presentation of information, and cues for orientation in the process. A questionnaire may employ technological tools from different disciplines, monitoring, follow-up, and providing feedback. Generating the questionnaire may be adapted to different cultural backgrounds, nationalities, and handicaps. Generating the questionnaire may include employing a reward system.

The system may continue to periodically generate and send questionnaires to clients that have successfully modified their behavior, and that wish to maintain the modification. The periodic sending of questionnaires may facilitate maintenance of the modification.

Data, such as questionnaires and the clients' responses, may be stored and analyzed in order to find connections among attributes, such as, for example, a relationship between gender and behavior. Through automatic learning and analysis of, connections and relationships among the stored data, the method may be automatically and continually improved. As more people use the system and overcome their addictions over time, the data may be analyzed and the system may become increasingly more effective.

A client may include a subscriber to a service, or a member of club or organization, for assisting in overcoming addictive behavior. Different services or organizations may be designed to serve different populations of clients (e.g., that are distinguished from one another by language or cultural differences, or that are characterized by different biological, physical, or behavioral attributes).

Examples of addictions or addictive behaviors may include, for example addiction to smoking, overeating, types of foods (e.g., chocolate, sweets, caffeine), internet (e.g., pornography, social media, games), work, sports, shopping, television, or other types of addictions.

An initial questionnaire may be a standard questionnaire that is common to all clients. Alternatively or in addition, an initial questionnaire may be common to a group of clients to which the client belongs. The group may include all clients that fit into a broad category, or to another plurality of clients (e.g., selected randomly or otherwise). The questions in the initial questionnaire may be intended to provide an initial assessment of the client.

The questions that are presented in each subsequent questionnaire of the series may be selected automatically in accordance with the responses that were provided by the client to one or more previous questionnaires or questions of the series. For example, questions of one of the subsequent questionnaires may be aimed at identifying any changes in the client's self-awareness, attitudes, motivation, behavior, or other changes. Questions of the questionnaires may be selected and formulated so as to build awareness and motivation for behavior change as related to the client's addiction. For example, the questions may be selected and presented in such a manner as to contribute to the client's understanding of the addiction path or behavior that could assist the client in overcoming an addiction. The questions may be selected and formulated so as to subtly induce changes in the client's attitudes or behavior. Questions may be accompanied by additional material. The additional material may create an atmosphere of trust, respect, acceptance and security. The additional material may include one or more of images, text or background colors, borders or background images, audio content, video content, instructions to perform one or more various activities, or any other technology that is available for use by web platforms.

For example, each questionnaire that is responded to by a client may be evaluated in light of a set of criteria. Evaluation of the questionnaire responses may result in a rating or risk assessment of the client with regard to a set of client characteristics. The client characteristics may be indicative of a set of physical, mental, or emotional traits, or other analyzed characteristics of the client. Analysis of questionnaire responses may use techniques known in the art. Such techniques may include comparative statistical formulas, underwriting knowledge, scientific research results, and predictive analysis tools. The analysis may provide a numerical value that characterizes the client and that may be compared with values for a relevant population. Analyzed client characteristics may include objective characteristics such as the client's sex, age, marital or family status, physical characteristics (e.g., height, weight, blood pressure, body build, results of blood or urine tests, or other physical characteristics), prescription medications taken, education, profession, income level, habits (e.g., cigarettes smoked per day, alcoholic drinks per day, hours spent on various activities), or other objective physical or other characteristics.

Client characteristics may include personality traits, attitudes and ways of interacting with the environment that are capable of evaluation by a client's response to a questionnaire. Questions to evaluate such traits may request the client to indicate a preference among various described scenarios or courses of action. Such traits may include, for example a predominant avenue of perception of the environment (auditory, visual, through bodily sensations). For example, a numerical value may be assigned to each client characteristic. The numerical value may be indicative of a strength or dominance of the corresponding trait or characteristic relative to a range or scale of possible strengths or dominance. The results of this evaluation may be utilized to determine (in subsequent questionnaires) a choice of specific words, expressions, or other content that are best suited to the client's personality traits. The selection may increase a level of ease of the client.

Content of a subsequent questionnaire that is to be generated may be selected from a database of questionnaires or constructed by selecting questions from a database of questions. The questions or a questionnaire may be selected in accordance with the client characteristics that were determined from responses to one or more previous questionnaires. The questions of subsequent questionnaires may be selected according to a set of criteria. For example, the criteria may include the clients' progress in a process as compared to a model on which the method is based, the clients' level of readiness to proceed to the next questionnaire (as determined by professional methodologies), identification of clients who are suited for continued participation, and identification of clients who require professional (face-to-face) help.

A position of a question in a subsequent questionnaire may be similarly determined in accordance with various criteria.

A system for questionnaire generation may be based on a web platform and business intelligence (BI) technology. The system may support the interactive questionnaire process and may employ data mining, predictive analysis tools, and statistical formulas. The system may provide historical and current data analysis, prognoses, and may enable research and prediction. The questionnaire-client interface may enable animation and may be designed to be user friendly and intuitive for the client. The reports delivered to the client or another end user may be in the form of clear reports that present the information using understandable and simple graphics and logic.

The system is configured to execute an access control module to ensure client identification. The system is configured to execute a questionnaire generation module that generates the questions automatically according to the client's response to previous questions and based on rules that result from execution of a rule generation module. An initial questionnaire may be general. In accordance with the client's response to the initial questionnaire, the may be applied to select questions from the question database. The question database may include text questions or other types of questions such as video/game/picture content with multi-sensory impact.

The system supports interactive processes with regard to the questionnaires. The system may apply such techniques as data mining and predictive and statistical analysis. The system may employ a range of features and gaming tools such as, for example, anthropomorphism of human body parts, virtual friends, cartoons and animation, video, and photographic and musical elements.

The client's responses may be analyzed by applying a predictive analytics tool such as SPSS or SAS, and the results of the analysis may be maintained in a client database. The results may input into the rules engine. The rules engine sends rules to the question generator in order to create the next questionnaire. The system includes an evaluation module that calculates the risk assessment and the client's characteristic index according to an algorithm. Results of execution of client evaluation may be used to create or modify client data. The system generates a feedback report and sends it to the user with a frequency that varies according to system parameters. The client database keeps a history of all the clients. The clients' responses may be periodically evaluated and behavior change models may be created or updated. The new or revised behavior change models may used by the rules engine. The system includes tables that contain parameters such as type of addictions, type of diseases, drugs lists, actuarial tables, BMI tables, or other types of tables. The tables can be updated from external or internal information sources.

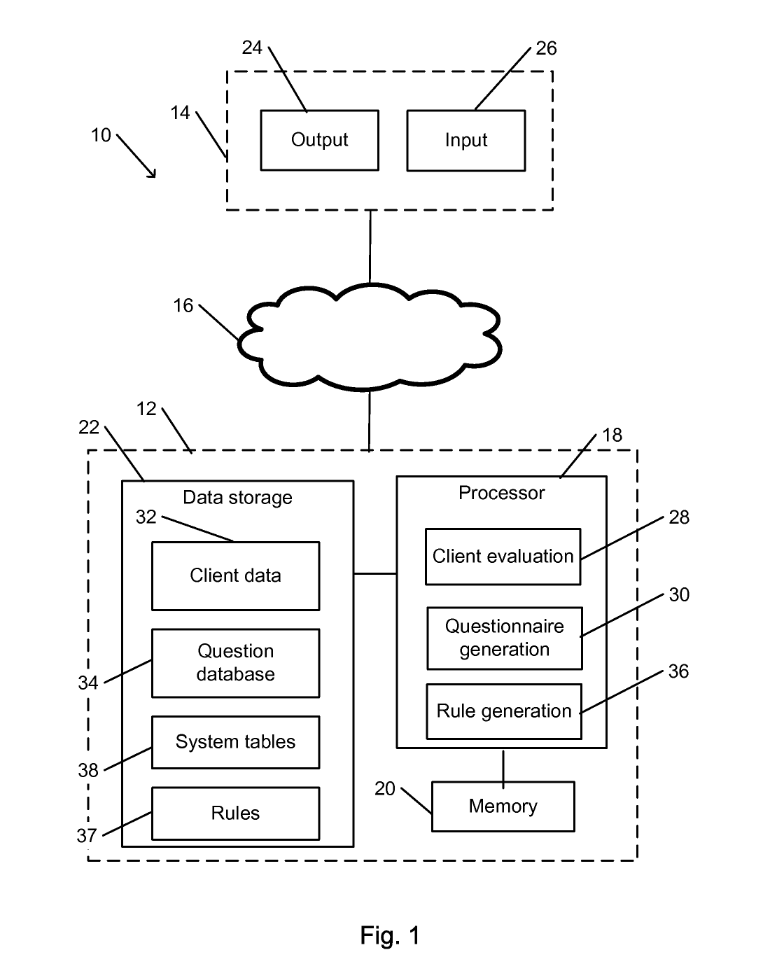

FIG. 1 is a schematic drawing of a system for questionnaire generation for overcoming of addictive behavior, in accordance with an embodiment of the present invention.

Questionnaire generation system 10 includes a server 12 that is capable of communication with one or more client terminals 14. For example, each client terminal 14 may communicate with server 12 via a network 16.

For convenience, server 12 is shown with data processing and data storage functionality, and client terminal 14 is shown with input and output functionality. However, the functionality may be otherwise distributed among server 12 and client terminal 14. In particular, part or all of the data processing and data storage functionality may be included in one or more client terminals 14, and part or all of the data input or output capability may be included in server 12.

Server 12 may include a single computer, or a plurality of intercommunicating computers. Client terminal 14 may be located near to or remotely from server 12. For example, when client terminal 14 is located near to (e.g., in the same room or building as) server 12, network 16 may represent a wired or wireless direct connection, or a local network. In this case, client terminal 14 may be provided by an operator of server 12. When client terminal 14 is located far from server 12, network 16 may represent a wired or wireless communications network such as the Internet, a cable or satellite television network, or a telephone network. In such a case, client terminal 14 may represent a home, workplace, or portable computer that is provided by a client of questionnaire generation system 10.

Server 12 includes processor 18. For example, processor 18 may include one or more processing units, e.g. of one or more computers. Processor 18 may be configured to operate in accordance with programmed instructions stored in memory 20. Processor 18 may be capable of executing an application for questionnaire generation.

Processor 18 may communicate with memory 20. Memory 20 may include one or more volatile or nonvolatile memory devices. Memory 20 may be utilized to store, for example, programmed instructions for operation of processor 18, data or parameters for use by processor 18 during operation, or results of operation of processor 18.

Processor 18 may communicate with data storage device 22. Data storage device 22 may include one or more fixed or removable nonvolatile data storage devices. For example, data storage device 22 may include a computer readable medium for storing program instructions for operation of processor 18. It is noted that data storage device 22 may be remote from processor 18. In such cases data storage device 22 may be a storage device of a remote server storing programmed instructions in the form of an installation package or packages that can be downloaded and installed for execution by processor 18. Data storage device 22 may be utilized to store data or parameters for use by processor 18 during operation, or results of operation of processor 18. Data storage device 22 may be utilized to store rules 37 that are applicable in generating a questionnaire.

For example, processor 18 may be configured to execute client evaluation module 28. Execution of client evaluation module 28 may include presenting a questionnaire to a client via client terminal 14 and evaluating the client's responses to the questionnaire and may include risk assessment that calculates a characterizing index. Execution of client evaluation module 28 may include evaluation of the client's responses in consideration of responses by other clients to questionnaires that were previously presented to those other clients. Results of execution of client evaluation module 28 may be used to create or modify client data 32. Client data 32 may include a set of values that are indicative of various physical or psychological characteristics of each evaluated client and the characterizing index. Client data 32 may be stored on data storage device 22. System tables 38 may include parameters such as type of addictions, type of diseases, drug lists, actuarial tables, BMI tables, or other tables. System tables 38 may be updated from external or internal information sources. System tables 38 may be utilized in execution of client evaluation module 28, questionnaire generation module 30, or rule generation module 36.

Processor 18 may be configured to execute questionnaire generation module 30. Execution of questionnaire generation module 30 may include selecting a questionnaire or a plurality of questions from a question database 34. Question database 34 may be stored on data storage device 22. Question database 34 may include complete or partial questionnaires, or questions that may be assembled into a questionnaire. Execution of questionnaire generation module 30 may include modifying a selected questionnaire by addition of, or substitution of included questions by, questions that are selected from question database 34.

Rules 37 may be generated via execution of rule generator module 36 or otherwise (e.g., by a programmer). Rules 37 may be applied by questionnaire generation module 30 in selecting questions from question database 34. Execution of rule generator module 36 may analyze rules 37 in accordance with accumulated information (e.g., gathered from client responses, from internal or external databases, or other sources). As a result of the analysis, execution of rule generator module 36 may generate additional rules 37 or modify an existing rule of rules 37.

Question database 34 may include properties of presented questions (e.g., fonts, text and background colors, accompanying images or sounds, or other properties), tasks, audio or video content, game content, or other components of a questionnaire. Questions or a questionnaire may be selected from question database 34 on the basis of client data 32. For example, each question in question database 34 may be characterized by a set of characteristics. The set of characteristics may be indicative of a suitability of inclusion of each question of question database 34 in a questionnaire that is to be presented to a client that is characterized by data in client data 32.

Client terminal 14 may be registered with a service that operates server 12. For example, a client who wishes to cause client terminal 14 to connect to server 12 via network 16 may be required to provide identifying information (e.g., user name and password) before the connection is made. Once the connection is made, components to client terminal 14 may communicate with components of server 12.

Processor 18 may communicate with output device 24, e.g., of client terminal 14. For example, output device 24 may include a computer monitor or screen. Processor 18 may communicate with a screen of output device 24 to present a questionnaire to a client, or to present visible or audible content that is intended to accompany presentation of a questionnaire. In another example, output device 24 may include a printer, display panel, speaker, or another device capable of producing visible, audible, or tactile output.

Processor 18 may communicate with input device 26, e.g., of client terminal 14. For example, input device 26 may include one or more of a keyboard, keypad, pointing device, microphone, or other device for enabling a user to input data or instructions for operation of processor 18. For example, in put device 26 may be operated by a client to input responses to a presented questionnaire.

A user interface that cooperates with input device 26 and output device 24 may be based on technology used in computer games.

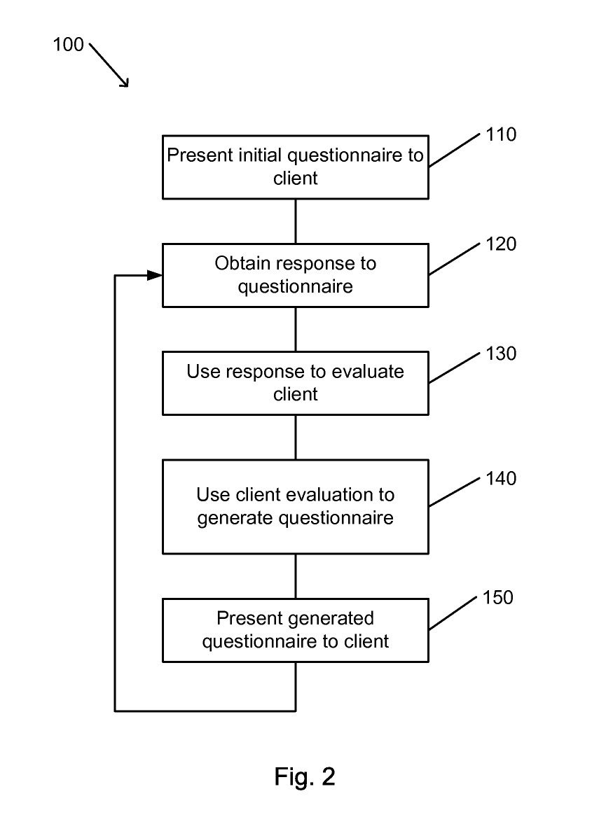

FIG. 2 is a flowchart depicting a method for questionnaire generation for overcoming of addictive behavior, in accordance with an embodiment of the present invention.

Questionnaire generation method 100 may be executed by a processor of a server of a system for questionnaire generation. Questionnaire generation method 100 may be executed automatically in response to one or more predetermined events. For example, the event may initiate execution of questionnaire generation method 100 may include registration of a client with a service for facilitating the overcoming of an addiction. Registration of the client may be subject to approval or review by a supervisor or operator of the service. The event may include receipt of an indication from the client that the client is ready to start the process, or of an indication from a supervisor that the client should start the process.

One or more operations of questionnaire generation method 100 may be executed in response to further events. For example, one or more operations of questionnaire generation method 100 may be executed upon receipt of a response of the client to a previous questionnaire. One or more operations of questionnaire generation method 100 may be executed upon receipt of an indication that a client is available to respond to a questionnaire. One or more operations of questionnaire generation method 100 may be executed after a predetermined interval or period of time has elapsed since a response was received to a previous questionnaire. The period of time may vary. For example, the period of time may be longer (e.g., one year) during a maintenance phase than during a stage during which behavior self-modification is being facilitated (e.g., one day, a few days, one week, a few weeks, one month, a few months).

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

An initial questionnaire may be presented to a client (block 110). For example, the initial questionnaire may be presented on a device that is permanently or temporarily associated with the client. The device may be proximal to, or remote from, the processor that executes questionnaire generation method 100. The server may send the initial questionnaire to a remote client device via a network connection.

The initial questionnaire may be common to all clients. Alternatively or in addition, the initial questionnaire may be common to all clients within a particular group or subset of clients. A client may be associated with a subset of clients based on initial information that is provided by the client, e.g., at a time of registration. For example, the subset may include those clients that are seeking to solve a particular addiction, or clients who share a common background (e.g., nationality or culture, age group, gender, or other common background).

The questions in the initial questionnaire may be intended to evaluate various characteristics of the client. Questions may be presented in written form or in an audio format. Questions may be accompanied by additional present content in visible or audible form, or otherwise. A question may refer to the presented content.

A response to a previously presented questionnaire is received (block 120). The previously presented questionnaire may include an initial standard questionnaire, or to a questionnaire that is generated as described below.

For example, the client may enter a response using a client device by operating a user interface. Typically, a response includes entering a numerical value (e.g., representing a height, weight, age, or other value), or selection of a true answer or preference from among a set of possible responses.

The received response is examined to automatically evaluate one or more characteristics of the client (block 130). The characteristics may be evaluated in accordance with various criteria or techniques. The evaluation may include determining a risk assessment for the client that may be expressed as a characterizing index for the client. Analysis of the response may include application of one or more statistical techniques or formulas, application of results of published or unpublished scientific studies, and may include predictive analysis. Analysis of the response may by analyzed in light of responses of other clients to questionnaires that were previously presented to those other clients.

The evaluation may be stored in a client data database, or elsewhere. For example, the evaluation may be stored on a device that is associated with the client so as to contribute to protection of the client's privacy.

One or more characteristics of the client may be inferred from the responses. For example, each possible response to a question may be assigned one or more scores. Each of the scores may reflect a trait of the client that is indicated by that response. For example, the answers to a cluster of questions may indicate that the client is inclined to react to specific situations mainly through a mental, emotional, or behavioral response. A numerical or other score may be assigned to a response to reflect a degree to which that response is indicative of a particular trait. For example, scores for various responses may be included in a question database together with a question. The scores may be assigned by one or people with psychological or related training or experience. For example, the scores may be assigned at the time that the question is originally written or added to the question database.

Evaluation of the client responses may relate to such factors or criteria as physical or actuarial factors (e.g., gender, pregnancy, body mass index (BMI), pregnancy, weight fluctuations, body dimensions (e.g., circumference of high or waist, or other physical factors), personality or behavioral traits (e.g., personality type, sensitivity to various stimuli (tactile, aural, visual), dominant forms of reaction to circumstances (e.g., emotional, properness, intellectual), inner or emotional peace or unease, openness to change), addictive behavior (e.g., to smoking, alcohol, caffeine, exercise, television, internet, food or related eating habits, past traumatic events, sources of emotional stress), required courses of action (e.g., increasing awareness of self and surroundings, increasing awareness of consequences, improving self image or self esteem, or other courses of action), or other criteria.

For example, a question to determine sensitivity to various environmental stimuli may ask the client to indicate a preference among different vacation destinations, with one described in terms of feelings and sensations (e.g., including terms such as “calm”, “breeze”, “relaxation”, “warmth”, “freedom”, “restfulness”, “tickling”, “embracing”), one in terms sounds (e.g., “quiet”, lacking “noise” or “tumult”, “tones”, “tweeting”, “rustling”, “dripping”, “whistling”), and one in terms of sights (e.g., “picturesque”, “color”, “light”, “scene”, “blending”, “vista”, “beautiful”, “color matching”, “hues”). As a result of the client's responses to this and other questions, the client may be classified as being sensual, aural, or visual. For example, a score may be assigned to the client's affinity to each of the descriptions. The result may be applied in selecting consequent questions or questionnaires. For example, a client determined to be sensual to a large degree may be presented with at least some questions and messages couched in terms of sensations, and may be accompanied by visual elements related to sensation (e.g., petting an animal). A client who is determined to be aural to a large degree may be presented with at least some questions and messages couched in terms related to hearing, and may be accompanied by sounds (e.g., music) or an image related to listening (e.g., of a person wearing earphones). A client who is determined to be visual to a large degree may be presented with at least some questions and messages couched in terms related to seeing, and may be accompanied by images related to seeing (e.g., of a person reading a book).

As another example, a question to determine a classification of the client in terms of modes of approaching situations may ask the client to indicate whether, while eating, the client is occupied with thoughts (e.g., indicative of an intellectual approach), is occupied with savoring the food (e.g., indicative of emotional approach), or is occupied with work or other tasks (e.g., indicative of a behavioristic approach). As a result of the client's responses to this and other questions, the client may be assigned scores (e.g., percentages) rating a degree of dominance of each approach (e.g., behavioristic, intellectual, or emotional) for that client. The result may be used in formulating questions in subsequent exams to increase the emotional side of the client. For example, for a client whose emotional component is low, a next questionnaire may have a yellow background, and a following questionnaire may have a blue background.

As another example, in order to increase the client's awareness of the client's emotions, the client may listen to an audio clip instructing the client to respond to following questions by asking oneself how the question made the client feel. The client may be further instructed to ask the question “How does this make me feel?” in all of the client's interactions. A following question may ask the client to answer the question “To what extent would you like to pay attention to your feelings throughout the day?” The client's response may be utilized in generating a subsequent questionnaire. For example, a questionnaire for a client who likes to pay attention to feelings may include many questions that express emotions, and few or no questions whose content is aimed at developing openness to emotions. On the other hand, a questionnaire for a client who does not like to pay attention to feelings may include few or no questions that express emotions, and many questions whose content is aimed at developing openness to emotions. The following questionnaire may also include questions aimed at determining whether the client noticed any internal change as a result of responding to the previous questionnaire.

As another example of increase the client's awareness of emotions, the client may be asked to imagine a situation in which a driver of a vehicle suddenly cuts into the lane in which the client is driving and almost causes an accident. The client is requested to indicate how the client expects to react. Options may include motioning or protesting to the other driver, being upset but doing nothing, or not being disturbed. A response that selects the latter option may be indicative (e.g., in light of responses to other questions of the questionnaire) to be deficient in emotionality. The client's response may also contribute to the client becoming aware of this lack of emotionality. For example, the client may, when faced with an actual similar situation a few days later, may feel anger.

As another example, a question may include guiding (e.g., by audio content) the client in meditation. The client may be asked to indicate whether the client had practiced meditation previously (e.g., with answers ranging from never to very often). The client may also be asked to indicate what the client felt during meditation. The responses may include a feeling (e.g., dizziness, incapability to close eyes, physical discomfort, restlessness, neck pain, or other feeling), an emotion (e.g., joy, fear, anger, or another emotion), or an insight (e.g., it is difficult to sit motionless, my thoughts do not stop, I cannot relax, or another insight). For example, a client whose responses to previous questionnaires have been evaluated as indicating a high degree of workaholism may have indicated feeling dizziness during the meditation. This indication may increase awareness by the client (e.g., in connection with a separately determined indication from another question or questionnaire of feelings of dizziness or inability to sleep when trying to take an afternoon nap) that the client is so addicted to work as render the client incapable of taking a break and resting. As a result of the understanding, the client may begin to successfully take short breaks and may begin to feel increased enthusiasm and decreased fatigue. Eventually, the client may become capable of napping.

As another example, a group of questions may ask if the client “Do you ever complement yourself” (possible answers may include: yes, no, to myself, in front of others), “Have you done something significant for yourself during the past year?” (e.g., no, or enrolled in a course or health club), and “Do you ever wonder if you take care of your body properly?” (yes, no, occasionally or when anther person comments). A client that was previously evaluated as having a strong need to be loved by others (typical of a person with a low level of self love) may have answered “no” to all these questions. As a result of responding to the questions, the client may increase awareness of self-neglect.

The client may take advantage of an offered opportunity to purchase and regularly use a membership in a club or organization. A member of the club or organization may use the system to overcome any addictive behavior

A client may be evaluated by applying an evaluation algorithm to the various scores that result from the client's responses, the scores being part of the characterizing index. For example, the algorithm may include calculating a sum or average. In some cases, the algorithm may include excluding extreme or outlying scores. The algorithm may include applying one or more other arithmetic or statistical operations. The result of the evaluation may be a set of one or more numerical values or other values that each is indicative of a status of the client with respect to a particular personality trait, attitude, or other characteristic.

The evaluation of the client may include detection of a change in a client characteristic over time. For example, one or more previous evaluations may be compared with a current evaluation. The comparison may yield a tendency or trend in a characteristic of the client. The tendency may be positive in that the change is considered to contribute positively to overcoming or weaning from an addiction, or may be negative in that the change may be considered to inhibit or deter overcoming the addiction.

In some cases, client evaluation may identify a client as not being suitable for further work with questionnaires, e.g., who requires personal (face-to-face) professional intervention.

The client evaluation may be utilized to automatically generate a questionnaire (block 140). Generating the questionnaire may include selecting questions for inclusion in the generated questionnaire, or selecting a previously assembled questionnaire. The selection of questions or a questionnaire may include application of a set of rules or criteria based on the client evaluation. The criteria may incorporate or refer to a result of qualitative or quantitative analysis of single or multiple questions. The criteria may refer to client data that is derived from various sensor readings, or application of various fields and disciplines.

Questions or questionnaires may be selected from a question database. For example, a client evaluation may indicate one or more behaviors or attitudes that are to be modified. The self-modification of behavior may be selected as contributing to enabling the client to overcome an addiction. In some cases, for example, an algorithm that is applied to the client evaluation may yield a set of priorities for behaviors for self-modification. Application of the algorithm may assign a priority score to each client characteristic that is to be modified. Questions for inclusion in the questionnaire may be selected randomly from a set of questions that are included within a particular category or that conform to a set of criteria.

For example, a series of rules or criteria may be applied to one or more questions from the database to determine if the question is to be included in a questionnaire. The criteria may be applied to determine into which questionnaire or questionnaires from among a series or sequence of questionnaires a question is to be included. Application of the criteria may determine a position for placement of a selected question within a questionnaire (e.g., relative to other questions in that questionnaire). The applied criteria may relate to results of analysis of previous responses, to statistical comparison of a client with other clients or another population, comparison with results of scientific or clinical studies, prognosis or other predictions, a status of the client's current health, criteria for question selection, models that relating to client behavior, or other criteria.

When a client responds to a question, the act of responding itself may be expected to subtly or obviously contribute to or facilitate self-modification of behavior or attitudes. Such self-modification may include, for example, increasing self-awareness or motivation. In some cases, a setting for the question (e.g., background scene or color, accompanying sound, font or color of test, accompanying visible or audible message, or other setting) may contribute to the self-modification. In some cases, responding to the question may be preceded by an activity that is to be performed by the client (e.g., exercise or other physical activity, meditation or other mental activity, viewing or listening to presented material, or another activity).

For example, in some cases, questionnaires may be generated according a sequence that corresponds to a sequence of objectives.

For example a sequence of questionnaires may be designed to gather information about the client. Questionnaires in this sequence may relate to one or more of typing the client, assessing the client's habits, inner peace, body image, medical history, satisfaction, openness to or fear of change, or thought and behavioral patterns.

Another sequence may be aimed at and to provide sufficient motivation so as to trigger responsiveness to subsequent questionnaires. Questionnaires in this sequence may, for example, aim to affect the client by one or more of increasing the client's awareness of negative aspects of not changing behavior patterns, development of self love and esteem, self discipline, allaying fears, motivation to change, identification of survival mechanisms, awareness of beliefs, or awareness of the emotional need for the client's addiction.

Another sequence may relate to imparting new information to the client and assessing the effect on the client. Questionnaires of this sequence may relate to imparting information regarding diseases and negative health-related effects that are associated with the addiction, negative effects of the addiction on the client's surroundings, assessing the client's cognitive and emotional response to imparted information, or increasing the client's capability to change.

Another sequence may relate to forming a plan of action. Questionnaires of this sequence may relate to increasing one or more of self-validation, awareness of the addictive behavior, or self control, to a personal action plan, concentration and imagination exercises, developing self love and self esteem, request for a physician's authorization to begin the plan, or presenting a plan of action or guidelines.

Another sequence may relate to executing the plan of action for self-modification of the client's behavior. Questionnaires of this sequence may relate to one or more of performing training via a network (e.g., a mobile telephone network or the Internet), informing close acquaintances of the change or intention to change, following up on meetings with professional counselors, providing guidance forums, and evaluating any modification of behavior.

Another sequence may relate to long-term maintenance and follow-up with regard to behavior modification. Questionnaires of this sequence may relate to one or more of training via a network to assimilate the changed behavior and periodic (e.g., annual) follow-up. Other sequences and types of questionnaires may be used, including randomized questions. The answers to randomized questions may be analyzed and may form the basis for a better understanding of the behavior modification of the clients.

The generated questionnaire may be presented to the client (block 150). For example, the modified questionnaire may be transmitted to a computer, terminal, workstation, smartphone, or other device that is associated with the client. In some cases, a delay may be imposed before the questionnaire is generated, or before a generated questionnaire is transmitted or presented to the client device. For example, an imposed delay may be designed to increase the benefit of responding to the questionnaire (e.g., by enabling the client to respond at a convenient pace without pressure, or in order to enable benefits of a previous questionnaire to become assimilated by the client

In some cases, the client may select when to respond to the questionnaire. The client may be required to respond within a predetermined period of time (e.g., in order to discourage extended or excessive contemplation when responding to a question where a spontaneous response is preferable). In some cases, a notification may be sent to the client when a questionnaire is sent. In some cases, a reminder may be sent after a predetermined interval.

The client's response may be received, the client evaluated, and a new questionnaire may be generated and presented to the client (repeating the operations of blocks 120 to 150). The process may be repeated until a predetermined period has expired, or until stopping or temporarily halting the process is indicated. For example, in some cases, an evaluation of the client may indicate that (face-to-face) professional counseling is recommended.

Occasionally, a report may be generated for presentation to the client. For example, the report may be generated after a predetermined number (e.g., three, or another number) of questionnaires have been responded to, or after another milestone or landmark is reached. The report may include the questionnaire and feedback regarding the client's responses, status, or progress. The report may include one or more of results of qualitative or quantitative analysis, or information from scientific research studies.

The system and method described herein may be advantageous over other systems and methods for overcoming addictive behavior. Use of questionnaires to facilitate behavior change may be perceived by the user as more natural or less threatening than other techniques (e.g., involving face-to-face interaction with a counselor or other people, or involving direct instruction to change). Since the process is essentially self-administered by the user, and since the user may be presented with follow-up questionnaires over a long period of time (e.g., several years or for the remainder of the user's life), the change in behavior may be deeper, longer lasting (or permanent), or more fully assimilated into the user's personality than change that is effected by other techniques.

Generation of a questionnaire may be part of a method to facilitate overcoming addictive behavior by a client.

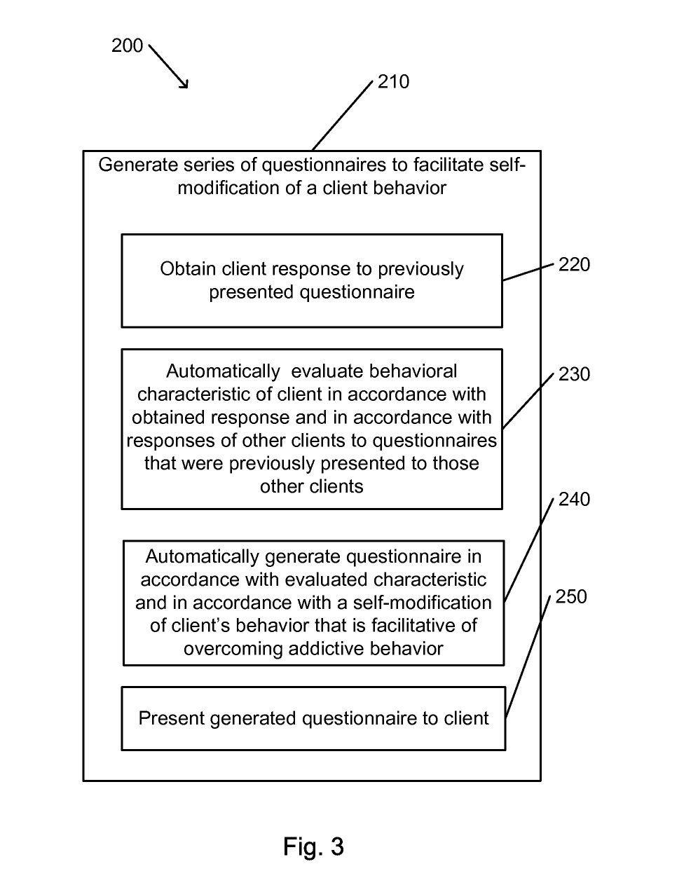

FIG. 3 is a flowchart depicting a method for facilitating overcoming of addictive behavior, in accordance with an embodiment of the present invention.

Addiction overcoming facilitation method 200 may be executed by a processor, e.g., of a server of a service for facilitating overcoming of addictions (block 210). The questionnaires are each designed to convey one or a plurality of messages to the client.

Generating each questionnaire of the series includes obtaining a response by the client to a previously presented questionnaire of the series of questionnaires (block 220).

The client is automatically evaluated with respect to one or more change components in accordance with the obtained response and in accordance with responses of other clients to questionnaires that were previously presented to those other clients (block 230).

The questionnaire is automatically generated in accordance with the evaluated change component and in accordance with a self-modification of the client's behavior and accordance with a self-modification of client's behavior that is facilitative of overcoming addictive behavior (block 240). The generated questionnaire is designed to facilitate the self modification of the behavior.

The generated questionnaire is presented to the client (block 250).

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for facilitating overcoming of addictive behavior, the method comprising:
generating a series of questionnaires to be presented to the client, the questionnaires designed to facilitate self-modification of a client behavior, wherein the generating of each questionnaire of the series of questionnaires comprises:
obtaining a response by the client to a previously presented questionnaire of the series of questionnaires;
automatically evaluating the client with respect to a change component in accordance with the obtained response and in accordance with responses of other clients to questionnaires that were previously presented to those other clients;
automatically generating that questionnaire in accordance with the evaluation with respect to the change component and in accordance with a self-modification of the client's behavior that is facilitative of overcoming the addictive behavior, the generated questionnaire being designed to facilitate the self-modification; and
presenting the generated questionnaire to the client.

2. The method of claim 1, wherein the previously presented questionnaire comprises a first questionnaire that is common to a group of clients to which the client belongs.

3. The method of claim 1, wherein said other clients comprise clients who have been evaluated as having successfully performed a self-modification that is facilitative of overcoming their addictive behavior.

4. The method of claim 1, wherein generating the questionnaire comprises selecting a question from a database of questions.

5. The method of claim 4, wherein selecting the question from the database of questions comprises applying a rule.

6. The method of claim 1, wherein generating the questionnaire comprises selecting visible, audible or game content for presentation to the client.

7. The method of claim 1, wherein generating the questionnaire comprises selecting an instruction to the client to perform an activity.

8. The method of claim 1, wherein generating the questionnaire comprises selecting a questionnaire from a database of questionnaires.

9. The method of claim 8, wherein generating the questionnaire further comprises substituting a question in the selected questionnaire with a question that is selected from a database of questions.

10. The method of claim 1, wherein generating the questionnaire comprises selecting a font, text color, or background color.

11. The method of claim 1, further comprising reporting a result of analysis of the client's response to one or more of the questionnaires.

12. The method of claim 1, wherein the questionnaires are presented to the client at predetermined time intervals.

13. The method of claim 11, wherein the time intervals are variable.

14. A system for generating a questionnaire to facilitate overcoming addictive behavior by a client, the system comprising a processor that is in communication with an input device and an output device that are accessible by the client, and with a data storage device for storing programmed instructions, the processor configured to:
obtain a response by the client to a previously presented questionnaire of a series of generated and presented questionnaires, each questionnaire of the series being designed to facilitate self-modification of a behavior of the client;
automatically evaluate the client with respect to a change component in accordance with the obtained response and in accordance with responses of other clients to questionnaires that were previously presented to those other clients;
automatically generate a questionnaire of the series in accordance with the evaluation with respect to the change component and in accordance with a self-modification of the client's behavior that is facilitative of overcoming the addictive behavior, the generated questionnaire designed to facilitate the self-modification; and
present the generated questionnaire on the output device so as to enable the client to operate the input device to respond to the presented questionnaire.

15. The system of claim 14 wherein the processor is configured to generate a first questionnaire that is common to a group of clients to which the client belongs.

16. The system of claim 14, wherein the data storage device is configured to store a database and the processor is configured to generate the questionnaire by selecting a question or a questionnaire from the database.

17. The system of claim 14, wherein the processor is configured to present to the client each generated questionnaire of the series after a predetermined interval from the time that the response to the previous questionnaire was obtained.

18. The system of claim 14, wherein the generated questionnaire comprises visible, audible or game content.

19. The system of claim 14, wherein the generated questionnaire comprises an instruction to perform an activity.
